(19) United States
(12) Patent Application Publication
(10) Pub. No.: US 2015/0145474 A1
(43) Pub. Date: May 28, 2015

(54) DEVICE FOR WIRELESS CHARGING OF A TERMINAL, INTENDED TO BE INSTALLED IN AN AUTOMOBILE

(71) Applicants: CONTINENTAL AUTOMOTIVE FRANCE, Toulouse (FR); CONTINENTAL AUTOMOTIVE GmbH, Hannover (DE)

(72) Inventor: Gilles JUREK, Plaisance Du Touch (FR)

(21) Appl. No.: 14/549,840

(22) Filed: Nov. 21, 2014

(30) Foreign Application Priority Data
Nov. 26, 2013 (FR) 1361643

(51) Int. Cl. B60L 11/18; H02J 7/00

(52) U.S. Cl. CPC B60L 11/182; H02J 7/0042; H02J 7/0052
USPC 320/108

(57) ABSTRACT

A device (100) for wireless electrical charging, intended to be installed in an automobile has a coil referred to as the “emitter coil” and a circuit for supplying the emitter coil, a first part (101) and a second part (102), at least one of which can move relative to the other between: a closed position of the device, in which the first and second parts are arranged so as to delimit a cavity for receiving a terminal (107); and an open position of the device adapted to allow insertion of the terminal. The second part has on the side of the first part a resilient element (103) including a rigid portion (110) which includes the emitter coil, the rigid portion being adapted to bear, when the device is in the closed position, against the terminal in the reception cavity, and to hold the terminal immobile against the first part.

### FIELD OF THE INVENTION

The field of the invention is the field of wireless electrical charging. More precisely, the invention relates to a device for wireless electrical charging of a terminal, such as a cellphone, having an electrical accumulator, intended to be installed in an automobile.

### BACKGROUND OF THE INVENTION

In the context of the wireless electrical charging of a terminal, having an electrical accumulator, there are devices for charging by induction and by magnetic resonance.

In a device for charging by induction, the terminal is placed on a plane electrical charging surface in an automobile.

The plane surface has an emitter coil which generates a variable magnetic field. The variations in the magnetic field induce the flow of an electric current in a receiver coil. To this end, the receiver coil faces the emitter coil. The variation in the magnetic field induces the electric current in the receiver coil, which charges the electrical accumulator.

Because the vehicle is in movement, whether when navigating turns, circular intersections, speed bumps, etc., the terminal, and therefore the electrical accumulator, moves on the plane surface. These movements contribute to degradation of the charge coming from the terminal, because the receiver coil no longer faces the emitter coil, and cause wear of it by mechanical friction.

### SUMMARY OF THE INVENTION

It is an object of the present invention to overcome all or some of the limitations of the solutions of the prior art, in particular those explained above, by providing a solution which makes it possible to limit the movements of the terminal having an electrical accumulator, due to the movement of the vehicle, in order to optimize its wireless charging.

To this end, and according to a first aspect, the invention relates to a device for wireless electrical charging, intended to be installed in an automobile, said device having a coil referred to as the “emitter coil” and a circuit for supplying said emitter coil, according to the invention, the device has a first part and a second part, at least one of which can move relative to the other between:
a closed position of the device, in which the first part and the second part are arranged so as to delimit a cavity for receiving a terminal having an electrical accumulator to be charged,
an open position of the device adapted to allow insertion of the terminal between said first part and said second part,

the second part having on the side of the first part a resilient means comprising a rigid portion which comprises the emitter coil, said rigid portion being adapted to bear, when the device is in the closed position, against the terminal in the reception cavity, and to hold said terminal immobile against the first part.

Such arrangements make it possible to hold the terminal, having an electrical accumulator, by means of the first part, the second part and the resilient means, in such a way that the receiver coil, located in the terminal, is immobile relative to the emitter coil, in order to optimize the wireless electrical charging of an electrical accumulator in an automobile.

Such arrangements make it possible to obtain a wireless electrical charging device for a terminal, irrespective of the thickness of said terminal. Thus, said emitter coil is located as close as possible to the receiver coil of the terminal.

In particular embodiments, furthermore, the device for wireless electrical charging of a terminal may have one or more of the following characteristics, taken separately or according to all technically possible combinations.

In particular embodiments, the second part comprises the supply circuit of the emitter coils.

In particular embodiments, the electrical connection is arranged between the supply circuit and the emitter coil of the first part, so that, when the device passes from the closed position to the open position, said electrical connection is deformed in torsion. Thus, by the deformation of the electrical connection in torsion, said electrical connection is degraded less.

In particular embodiments, the device for wireless electrical charging of a terminal has a wall, referred to as the “lower wall”, located below the device and delimiting, with the first part and the second part, the reception cavity of the device in the closed position. Thus, the terminal is held in the lower part of the device by the lower wall.

In particular embodiments, the device for wireless electrical charging of a terminal has a wall, referred to as the “side wall”, delimiting, with the first part and the second part, the reception cavity of the device in the closed position, located transversely at one end of the lower wall, with a length l less than a length L of the first and/or second part, when measuring the length with respect to the lower wall. Thus, the terminal is held in the lateral parts of the device by lateral walls.

In particular embodiments, the device for wireless electrical charging of a terminal has a guide element located on a side wall and/or on the lower wall and/or on the first part. Thus, insertion of the terminal into the device is facilitated.

In particular embodiments, the device for wireless electrical charging of a terminal has a locking system adapted to keep the device in the closed position.

In particular embodiments, the rigid portion, the resilient means and the first part, at least in a region in which the resilient means bears on the terminal and in which the first part is capable of being in contact with a terminal, referred to as contact regions, are made of flexible material or covered with a flexible material. Thus, when the device is in the closed position, the terminal is not damaged by the various contacts with the rigid portion, the resilient means or the first part.

In particular embodiments, the flexible material is an elastomer.

In particular embodiments, the first part and the second part can both move with respect to one another, and are coupled in rotation and/or in translation.

### BRIEF DESCRIPTION OF THE DRAWINGS

The invention will be understood more clearly on reading the following description, given by way of nonlimiting example and provided while referring to the figures, in which:

FIG. 1 represents a view of a device for wireless electrical charging of a terminal, according to one exemplary embodiment of the invention, in the open position.

FIG. 2 represents a view of the wireless electrical charging device of FIG. 1 in the closed position.

FIGS. 3 to 6 represent exemplary embodiments of resilient means of the wireless electrical charging device.

FIG. 7 represents a view of the device for wireless electrical charging of a terminal, according to one exemplary embodiment of the invention, in the closed position.

### DETAILED DESCRIPTION OF THE INVENTION

In the figures, references which are identical from one figure to another denote elements which are identical or similar. For reasons of clarity, the elements represented are not to scale, unless otherwise mentioned.

The present invention relates to a wireless electrical charging device 100 intended to be installed in an automobile. Said device has a coil, referred to as the “emitter coil”, a circuit for supplying said emitter coil, a first part 101 and a second part 102, at least one of which can move relative to the other. Said device has two positions. A closed position of the device 100, in which the first part 101 and the second part 102 are arranged so as to delimit a cavity for receiving a terminal 107 having an electrical accumulator to be charged. An open position of the device 100, which is adapted to allow insertion of the terminal 107 between said first part 101 and said second part 102.

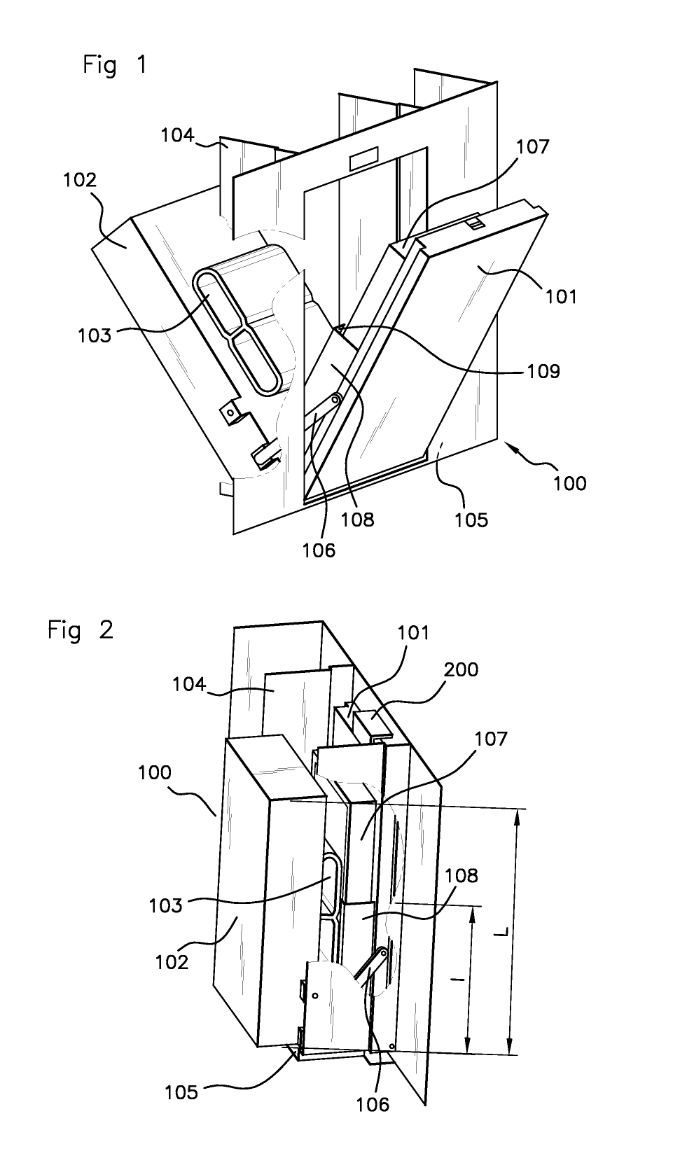

In a first exemplary embodiment of the invention, which is illustrated in FIGS. 1 and 2, the first part 101 has the emitter coil on the side of the second part 102. In the rest of the description, the case in which the first part 101 has only one emitter coil (not represented) will be discussed. There is nothing to prevent the device 100 from having a plurality of emitter coils according to other examples. In one embodiment of the invention, which is not represented, the device 100 has a plurality of coils distributed over the first part 101 in the direction of the second part 102. Thus, depending on the models of the terminals 107, the receiver coil located in a terminal 107 has its axis aligned with the axis of one of the coils of the first part 101, which will be the emitter coil.

The device 100 is intended for wireless electrical charging of a terminal 107, such as a cellphone, a tablet, an MP3 player, etc.

In the rest of the description, the case of electrical charging by induction (for example as specified by the WPC, Wireless Power Consortium) will be discussed without implying limitation. The invention is, however, applicable to other wireless electrical charging technologies, including magnetic resonance (for example A4WP, Alliance for Wireless Power).

FIG. 1 represents an exemplary embodiment of a device 100 for wireless electrical charging of a terminal 107, in the open position. FIG. 2 represents the device 100 of FIG. 1 in the closed position.

The terminal 107 is introduced into the device 100 in the open position, in such a way that the receiver coil of the terminal 107 is located on the side of the first part 101, in order for the charging of the electrical accumulator of the terminal 107 to take place.

In the example illustrated by FIG. 1, the first part 101 and the second part 102 can move in rotation. In an exemplary embodiment of the device, which is not represented, only one of the parts 101 or 102 is mobile.

As illustrated in FIG. 1, the second part 102 has a resilient means 103 on the side of the first part 101. In the exemplary embodiment of the resilient means of FIG. 1, the resilient means 103 is a tube with a double tunnel. Said resilient means is adapted to bear, when the device 100 is in the closed position, against the terminal 107 in the reception cavity, and to hold said terminal immobile against the first part 101.

The resilient means 103 is made of flexible material, or covered with a flexible material at least in the contact region. The flexible material is formed so as to maintain the external state of the terminal 107. The contact region is intended to mean the region in which the resilient means 103 bears on the terminal 107. The material used to maintain the state of the terminal 107 is preferably an elastomer, for example rubber. Said material protects the terminal 107 so that said terminal is not physically damaged by the resilient means 103. As illustrated in FIG. 2, in the closed position, the resilient means 103 is capable of bearing against the terminal 107 in the reception cavity.

The thickness of the uncompressed resilient means determines the minimum thickness of the terminals which can be held immobile in the closed position. The thickness of the uncompressed resilient means is therefore selected so that, in the closed position and in the absence of the terminal 107, the distance between the resilient means and the first part 101, referred to as the “minimum distance”, is less than the minimum thickness of the various terminals which it is intended to be able to charge. Said minimum distance is, for example, less than 10 millimeters, or less than 5 millimeters (said minimum distance may be zero if the resilient means bears, in the closed position, on the first part 101). Thus, the resilient means 103 can bear, in the closed position, on any terminal 107 with a thickness greater than said minimum distance.

The thickness of the resilient means 103, when it is maximally compressed, determines the maximum thickness of the terminals which can be accepted in the reception cavity of the device 100 in the closed position. The thickness of the resilient means 103 when maximally compressed is therefore selected so that, in the closed position, the distance between said maximally compressed resilient means and the first part 101, referred to as the “maximum distance”, is greater than the maximum thickness of the various terminals which it is intended to be able to charge. Said maximum distance is, for example, greater than 15 millimeters, or even greater than 20 millimeters. Thus, any terminal with a thickness less than said maximum distance can be accepted in the reception cavity of the device 100 in the closed position.

Thus, by virtue of the resilient means 103, the device 100 accepts terminals of different thicknesses in a range of the order of ten millimeters.

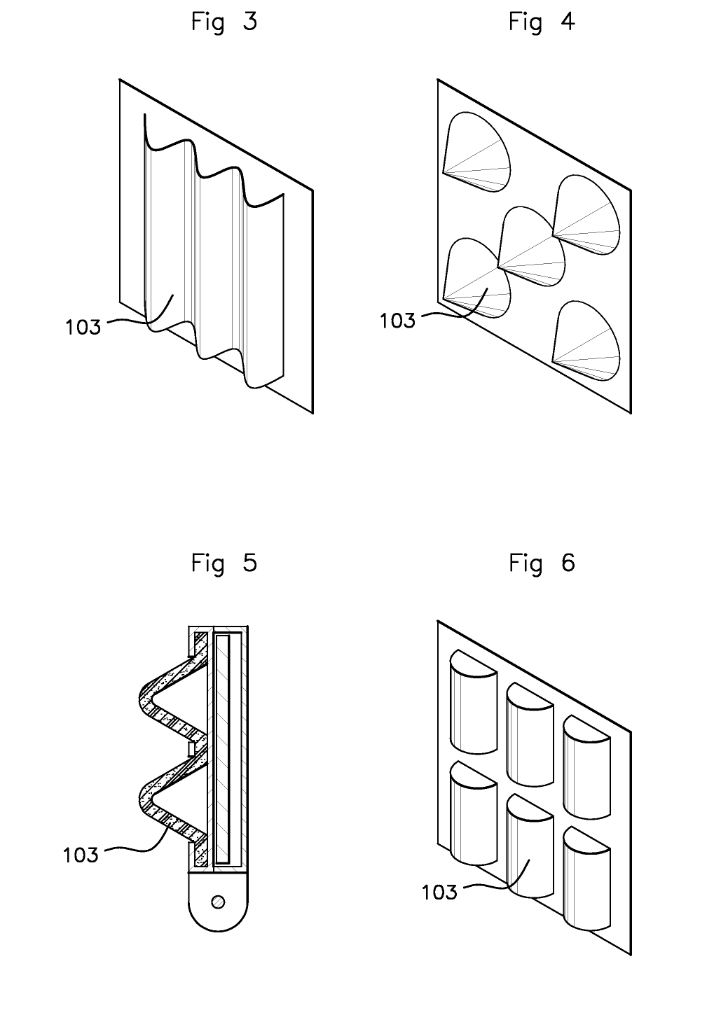

In the example of FIG. 1, the resilient means 103 is a tube with a double tunnel, although said resilient means may have other shapes and appearances, such as a monobloc cellular foam or bearing cones, as illustrated in FIGS. 3 to 6. Furthermore, in one nonlimiting exemplary embodiment of the invention, the resilient means 103 is a spring. In one exemplary embodiment, the resilient means is composed of a plurality of springs arranged on the surface of the second part 102 in the direction of the first part 101. Said springs may be different to one another. For example, the springs located in the upper part of the surface of the second part 102 have different properties to the springs located on the lower part of said surface. The different properties of the springs may, for example, be the type of spring, the stiffness of the springs, etc.

In the example illustrated by FIG. 1, the device 100 has a lower wall 105 and two side walls 108, one of which is not represented in FIG. 1. A lower wall 105 is intended to mean a wall located under the device 100 and delimiting, with the first part 101 and the second part 102, the reception cavity. A side wall 108 is intended to mean a wall which is located transversely at one end of the lower wall 105 and which, with the first part 101 and the second part 102, delimits the reception cavity of the device 100 in the closed position. In one exemplary embodiment of the invention, the device 100 only has a lower wall 105. In an alternative device, the device 100 has one side wall 108 on each side of the parts 101, 102. When the device 100 is in the closed position, the first part 101 and the second part 102 delimit a reception cavity for receiving a terminal 107 in order to charge it electrically. The lower wall 105 serves as a stop for the terminal 107, on which said terminal bears under the effect of gravity when it is put in place.

In one preferred embodiment, which can be seen in FIG. 1, the length l of the side wall 108 relative to the lower wall 105 is less than the length L of at least one of the parts 101, 102. Thus, when the device 100 is in the open position as illustrated in FIG. 1, insertion and removal of the terminal 107 between the first part 101 and the second part 102 is facilitated. In the nonlimiting example of FIG. 1, the two parts 101, 102 are coupled in rotation. In preferred embodiments, the two parts 101, 102 are coupled in translation. In another example, which is not represented, the two parts 101, 102 are coupled both in rotation and in translation.

The device 100 has a system for coupling the parts 101, 102, which is composed, in FIG. 1, of a bar 106. In the coupling system with a bar, the positions of the axes of rotation of the first part 101, of the second part 102 and of the bar 106 can be adjusted so as to adapt the displacement travels and the speeds of the parts 101, 102. In one exemplary embodiment of a system for bar coupling, one bar 106 is placed on each side of the device 100 for greater mechanical strength and so that the forces during the movements of the automobile are identical on each side of the device 100.

In the example of FIG. 1, the coupling system is produced by a bar although the coupling system may also be produced by other means, for example by means of gears. In another exemplary embodiment of the system for coupling between the first part 101 and the second part 102, the coupling system is produced by a bar 106 and by gears. In one exemplary embodiment of a system for coupling by gears, the axes of rotation of the first and second parts 101, 102 are aligned with the axes of each gear. In an alternative exemplary embodiment of a gear coupling system, the axes of rotation of the first and second parts 101, 102 and the axes of the gears are offset. This offset makes it possible to create an additional translational movement in a direction tangential to the surface of the terminal, allowing further holding of the terminal 107 toward the bottom of the device 100. In one exemplary embodiment of a gear coupling system, the wheels of the gears have different dimensions, with a view to differentiating the opening travels and the speed of movement of the parts 101, 102. In one exemplary embodiment of the invention, one gear system is arranged on each side of the device 100.

FIG. 1 represents the device 100 in the open position, having a guide element 109 located on the side wall 108. In this example, the guide element 109 is a wall making, with the side wall 108, an angle making it possible to facilitate insertion of the terminal 107 into the device 100. The guide element 109 of FIG. 1 creates a U-shaped profile with the first part 101 and the side wall 108. The guide element 109 of FIG. 1 makes it possible to ensure that the terminal 107 is directed towards the first part 101. In another exemplary embodiment of the invention, the lower wall 105 has a guide element such as a guide rail. In another example, the first part 101 has a guide element such as a visual reference (lines, etc.) making it possible to influence the user when placing the terminal 107, so that said user preferably positions the terminal 107 at the center of the reception cavity.

In the example of FIG. 1, the device 100 is integrated into a fixed support 104, which is integrated into the passenger compartment of the automobile, such as the instrument panel.

As indicated above, the device 100 has a circuit (not represented) for supplying the emitter coil. In one exemplary embodiment of the invention, the supply circuit is located in the first part 101. In one preferred embodiment, said supply circuit is separate from the first part 101, that is to say not integrated into this first part 101.

Advantageously, the circuit for supplying the emitter coil is located in the second part 102, in order to have a first part 101 which is thinner, in the case in which the first part 101 is arranged to the side of the user. A thinner first part 101 makes it possible to have a device 100 which is more esthetic and more ergonomic for the insertion and the removal of the terminal 107. It is because the device 100 opens by a minimum dimension necessary for insertion and removal of the terminal 107. Said minimum dimension corresponds to the thickness of the first part 101 and the thickness of the terminal 107. Thus, by having a thinner first part 101, the opening of the device 100 necessary for insertion and removal of the terminal 100 is smaller.

According to one exemplary embodiment of the invention, the circuit for supplying the emitter coil is located in a different part of the parts 101 or 102.

The device 100 has an electrical connection arranged between the circuit for supplying the emitter coil and the emitter coil.

In one exemplary embodiment, in which the circuit for supplying the emitter coil is located in the second part 102, a first end of the electrical connection is connected to one of the sides of the resilient means 103. A second end of the electrical connection is connected to the emitter coil, by the side of a reception cavity diagonally opposite the side of the resilient means 103 connected. Said electrical connection deforms, for example in torsion, which allows greater robustness of the electrical connection.

As illustrated by FIG. 2, the device 100 has a locking system 200 keeping the device 100 closed despite the force of the resilient means 103 on the terminal 107, which tends to separate the first part 101 and the second part 102. In FIG. 2, the locking system 200 has a magnet, located on the fixed support 104, and a metal part located facing the magnet in the closed position. In other exemplary embodiments of the invention, said locking system 200 is a bolt, a latch, etc.

In one exemplary embodiment of the invention, the device 100 has a system for damping the opening of the device 100.

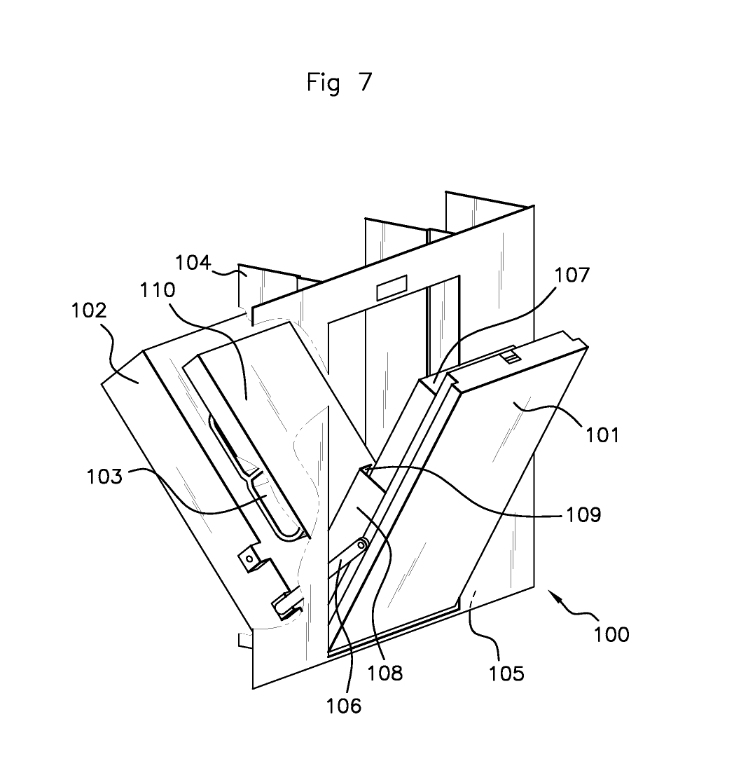

In a second exemplary embodiment of the invention, which is illustrated in FIG. 7, the device 100 has a first part 101 which comprises an emitter coil on the side of the second part 102, as well as an emitter coil which the resilient means 103 of the second part 102 comprises. This example is a preferred exemplary embodiment of the invention.

The resilient means 103 supports a rigid portion 110, which has an emitter coil on the side of the first part 101. As in the first example, said rigid portion 110 may have a plurality of emitter coils. In the rest of the description of this second example, the case in which the rigid portion 110 has only one emitter coil (not represented) will be discussed. In one exemplary embodiment of the invention, which is not represented, the device 100 has a plurality of coils distributed over the rigid portion 110 in the direction of the first part 101. Thus, depending on the models of the terminals 107, the receiver coil located in a terminal 107 has its axis aligned with the axis of one of the coils of the rigid portion 110, which will be the emitter coil.

The rigid portion 110 makes it possible to protect the emitter coil which it comprises from contact with the terminal 107 and the resilient means 103 when the device 100 is in the closed position. The thickness of the uncompressed resilient means determines the minimum thickness of the terminals which can be held immobile in the closed position. The thickness of the uncompressed resilient means is therefore selected so that, in the closed position and in the absence of the terminal 107, the distance between the rigid portion 110 and the first part 101, referred to as the “minimum distance”, is less than the minimum thickness of the various terminals which it is intended to be able to charge. Thus, the rigid portion 110 bears, in the closed position, on any terminal with a thickness greater than said minimum distance.

The thickness of the resilient means 103, when it is maximally compressed, determines the maximum thickness of the terminals which can be accepted in the reception cavity of the device 100 in the closed position. The thickness of the resilient means 103 when maximally compressed is therefore selected so that, in the closed position, the distance between the rigid portion 110 and the first part 101, referred to as the “maximum distance”, is greater than the maximum thickness of the various terminals which it is intended to be able to charge. Thus, any terminal with a thickness less than said maximum distance can be accepted in the reception cavity of the device 100 in the closed position.

In the exemplary embodiment of the invention illustrated by FIGS. 1 and 2, the terminal 107 is introduced into the device 100 in the open position, so that the receiver coil of the terminal 107 is located on the side of the first part 101, in order for the charging of the electrical accumulator of the terminal 107 to take place. The exemplary embodiment illustrated in FIG. 7 makes it possible to introduce the terminal 107 into the device 100 in the open position, so that the receiver coil of the terminal 107 is located on the side of the first part 101 or of the rigid portion 110. In both aforementioned cases of positioning the terminal 107 in the reception cavity, the charging of the electrical accumulator of the terminal 107 takes place for this second exemplary embodiment of the invention.

As in the example illustrated by FIGS. 1 and 2, an electrical connection is arranged between the supply circuit and the emitter coil of the first part 101, so that, when the device 100 passes from the closed position to the open position, said electrical connection is deformed in torsion. Said electrical connection is also arranged between the supply circuit and the emitter coil of the second part 102. In one exemplary embodiment of the invention, which is illustrated by FIG. 7, for economic optimization, said electrical connection arranged between the emitter coil of the rigid portion 110 and the second part 102 is integrated by means of the resilient means 103. In one exemplary embodiment of the resilient means 103, separate metal springs are arranged on the second part 102 in the direction of the first part 101. Each metal spring makes a particular signal travel to the emitter coil of the rigid portion 110. In another exemplary embodiment of the resilient means 103, said resilient means 103 is composed of synthetic elements incorporating conductive materials, for example fillers containing carbon.

In a third exemplary embodiment of the invention (not represented), the device 100 has only one emitter coil supported by the rigid portion 110 on the side of the first part 101. The thickness of the resilient means 103 is determined in the same way as for a device 100 having one emitter coil in the first part 101 and one emitter coil in the rigid portion 110.

The terminal 107 should be introduced into the device 100 in the open position, so that the receiver coil of the terminal 107 is located on the side of the rigid portion 110, in order for the charging of the electrical accumulator of the terminal 107 to take place.

The description above clearly illustrates that, by its various characteristics and their advantages, the present invention achieves the objectives which were set for it. In particular, the present invention makes it possible to hold the terminal 107 immobile against the first part 101 so that the wireless electrical charging of a terminal 107 is effective.

1. A device (100) for wireless electrical charging, intended to be installed in an automobile, said device having a coil referred to as the “emitter coil” and a circuit for supplying said emitter coil, characterized in that it has a first part (101) and a second part (102), at least one of which can move relative to the other between:
a closed position of the device (100), in which the first part (101) and the second part (102) are arranged so as to delimit a cavity for receiving a terminal (107) having an electrical accumulator to be charged,
an open position of the device (100) adapted to allow insertion of the terminal (107) between said first part (101) and said second part (102),
the second part (102) having on the side of the first part (101) a resilient means (103) comprising a rigid portion (110) which comprises the emitter coil, said rigid portion being adapted to bear, when the device (100) is in the closed position, against the terminal (107) in the reception cavity, and to hold said terminal (107) immobile against the first part (101).

2. The device as claimed in claim 1, characterized in that the second part (102) comprises the circuit for supplying the emitter coils.

3. The device as claimed in claim 2, characterized in that it has an electrical connection, said electrical connection being arranged between the supply circuit and the emitter coil of the first part (101), so that, when the device (100) passes from the closed position to the open position, said electrical connection is deformed in torsion.

4. The device as claimed in claim 1, characterized in that it has a wall referred to as the “lower wall” (105) located below the device (100) and delimiting, with the first part (101) and the second part (102), the reception cavity of the device (100) in the closed position.

5. The device as claimed in claim 4, characterized in that it has a wall, referred to as the “side wall”, (108) delimiting, with the first part (101) and the second part (102), a reception cavity of the device (100) in the closed position, located transversely at one end of the lower wall (105), with a length (l) less than a length (L) of the first and/or second part (101, 102), when measuring said length with respect to the lower wall (105).

6. The device as claimed in claim 5, characterized in that it has a guide element located on the side wall (108) and/or on the lower wall (105) and/or on the first part (101).

7. The device as claimed in claim 1, characterized in that it has a locking system (200) adapted to keep the device (100) in the closed position.

8. The device as claimed in claim 1, characterized in that the rigid portion (110), the resilient means (103) and the first part (101), at least in a region in which the resilient means (103) bears on the terminal (107) and in which the first part (101) is capable of being in contact with a terminal (107), referred to as contact regions, are made of flexible material or covered with a flexible material.

9. The device as claimed in claim 8, characterized in that the flexible material is an elastomer.

10. The device as claimed in claim 1, characterized in that the first part (101) and the second part (102) can both move with respect to one another, and are coupled in rotation and/or in translation.
